(19) United States
(12) Patent Application Publication
(10) Pub. No.: US 2021/0200539 A1
(43) Pub. Date: Jul. 1, 2021

(54) GENERIC LINEAR UNIT HARDWARE ACCELERATOR

(71) Applicant: Intel Corporation, Santa Clara, CA (US)

(72) Inventors: Mohamed Elmalaki, Gilbert, AZ (US); ElMoustapha Ould-Ahmed-Vall, Chandler, AZ (US)

(73) Assignee: Intel Corporation, Santa Clara, CA (US)

(21) Appl. No.: 16/729,336

(22) Filed: Dec. 28, 2019

(51) Int. Cl. G06F 9/30

(52) U.S. Cl. CPC G06F 9/3001; G06F 9/30021

(57) ABSTRACT

Embodiments of apparatuses, methods, and systems for a generic linear unit hardware accelerator are disclosed. In an embodiment, an apparatus includes a comparator, an exponential subunit, a multiplier subunit, and an adder subunit. The apparatus is to receive an input tensor, a threshold, an exponential enable, a scaling factor, and a bias factor and is to perform a transformation function on the input tensor to generate an output tensor.

### FIELD OF INVENTION

The field of invention relates generally to information processing, and, more specifically, but without limitation, to linear unit functions.

### BACKGROUND

The functions of linear units, including variants of rectified linear units and exponential linear units, are commonly used in deep learning networks. Consequently, a single information processing system may include a variety of linear units.

### BRIEF DESCRIPTION OF THE DRAWINGS

The present invention is illustrated by way of example and not limitation in the figures of the accompanying drawings, in which like references indicate similar elements and in which:

FIG. 1 is a block diagram of a generic linear unit hardware accelerator according to an embodiment of the invention;

FIG. 2A is a block diagram of an exponential subunit of a generic linear unit hardware accelerator according to an embodiment of the invention;

FIG. 2B is a block diagram of a multiplier subunit of a generic linear unit hardware accelerator according to an embodiment of the invention;

FIG. 2C is a block diagram of an adder subunit of a generic linear unit hardware accelerator according to an embodiment of the invention;

FIG. 3 is a diagram illustrating a method of operation of a generic linear unit hardware accelerator according to an embodiment of the invention;

FIG. 4A is a block diagram illustrating both an exemplary in-order pipeline and an exemplary register renaming, out-of-order issue/execution pipeline according to embodiments of the invention;

FIG. 4B is a block diagram illustrating both an exemplary embodiment of an in-order architecture core and an exemplary register renaming, out-of-order issue/execution architecture core to be included in a processor according to embodiments of the invention;

FIG. 5 is a block diagram of a processor that may have more than one core, may have an integrated memory controller, and may have integrated graphics according to embodiments of the invention;

FIG. 6 is a block diagram of a system in accordance with one embodiment of the present invention;

FIG. 7 is a block diagram of a first more specific exemplary system in accordance with an embodiment of the present invention;

FIG. 8 is a block diagram of a second more specific exemplary system in accordance with an embodiment of the present invention; and

FIG. 9 is a block diagram of a SoC in accordance with an embodiment of the present invention.

### DETAILED DESCRIPTION

In the following description, numerous specific details, such as component and system configurations, may be set forth in order to provide a more thorough understanding of the present invention. It will be appreciated, however, by one skilled in the art, that the invention may be practiced without such specific details. Additionally, some well-known structures, circuits, and other features have not been shown in detail, to avoid unnecessarily obscuring the present invention.

References to “one embodiment,” “an embodiment,” “example embodiment,” “various embodiments,” etc., indicate that the embodiment(s) of the invention so described may include particular features, structures, or characteristics, but more than one embodiment may and not every embodiment necessarily does include the particular features, structures, or characteristics. Some embodiments may have some, all, or none of the features described for other embodiments. Moreover, such phrases are not necessarily referring to the same embodiment. When a particular feature, structure, or characteristic is described in connection with an embodiment, it is submitted that it is within the knowledge of one skilled in the art to effect such feature, structure, or characteristic in connection with other embodiments whether or not explicitly described.

As used in this description and the claims and unless otherwise specified, the use of the ordinal adjectives “first,” “second,” “third,” etc. to describe an element merely indicate that a particular instance of an element or different instances of like elements are being referred to, and is not intended to imply that the elements so described must be in a particular sequence, either temporally, spatially, in ranking, or in any other manner.

Also, the terms “bit,” “flag,” “field,” “entry,” “indicator,” etc., may be used to describe any type or content of a storage location in a register, table, database, or other data structure, whether implemented in hardware or software, but are not meant to limit embodiments of the invention to any particular type of storage location or number of bits or other elements within any particular storage location. The term “clear” may be used to indicate storing or otherwise causing the logical value of zero to be stored in a storage location, and the term “set” may be used to indicate storing or otherwise causing the logical value of one, all ones, or some other specified value to be stored in a storage location; however, these terms are not meant to limit embodiments of the present invention to any particular logical convention, as any logical convention may be used within embodiments of the present invention.

Also, as used in descriptions of embodiments of the invention, a “I” character between terms may mean that an embodiment may include or be implemented using, with, and/or according to the first term and/or the second term (and/or any other additional terms).

As mentioned in the background section, a single information processing system may include a variety of linear units. Each of these may have any number of inputs and any number of outputs, any number of which may be different for different linear units, so different linear units may present different interfaces and/or be accessed differently by a programmer, compiler, model trainer, etc. Therefore, it may be desirable, using embodiments of the present invention, to present a single, simple interface to a linear unit that performs a variety of functions.

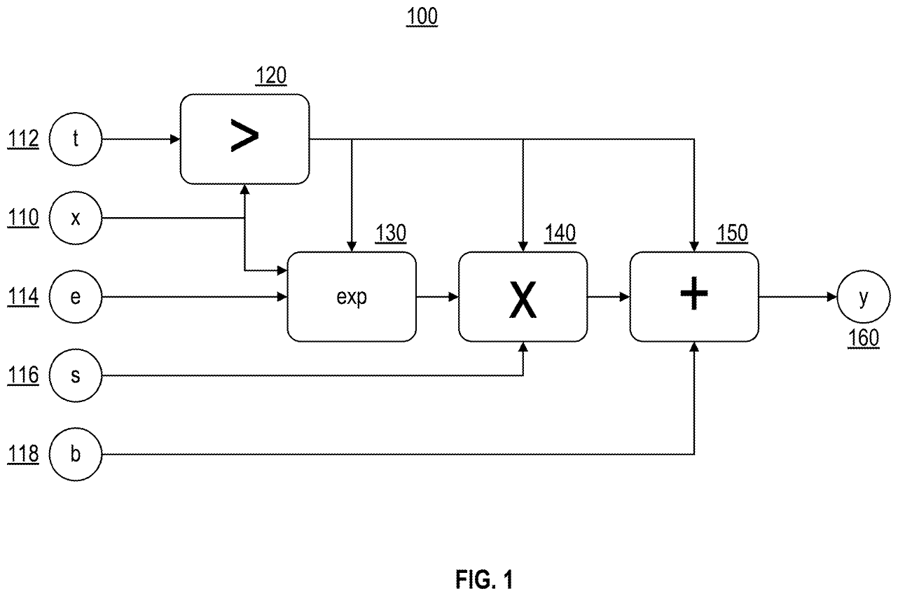

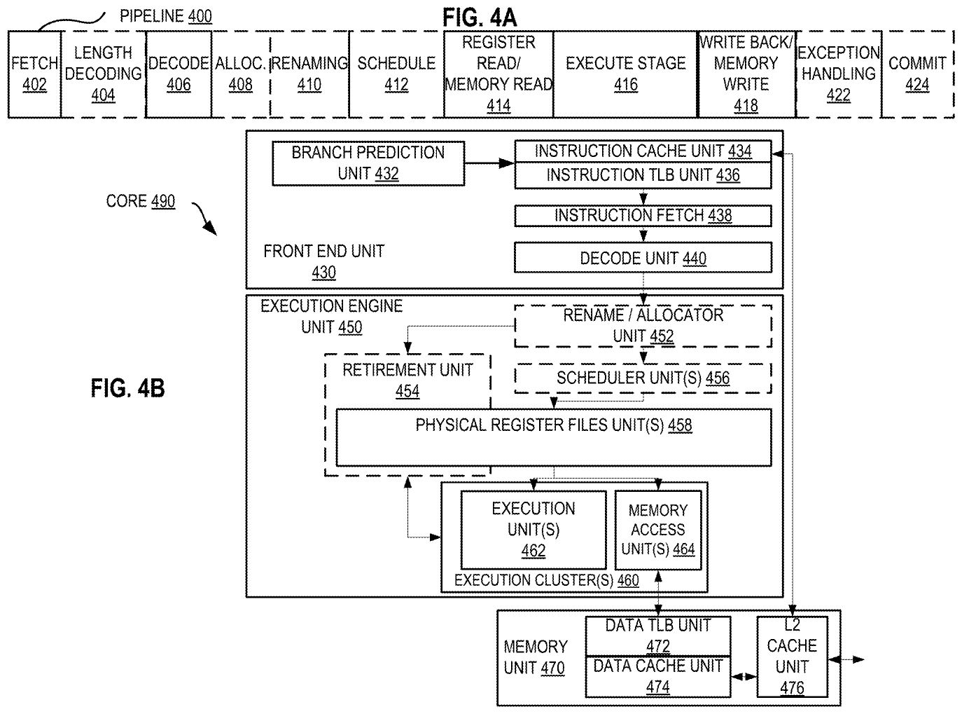

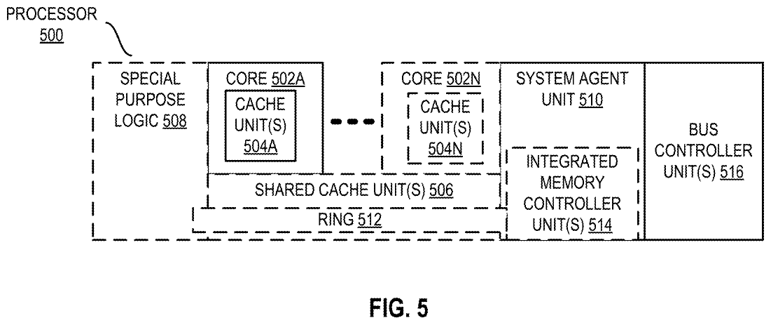

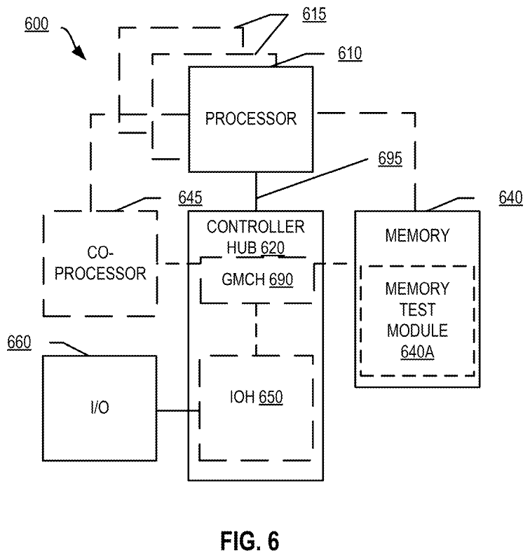

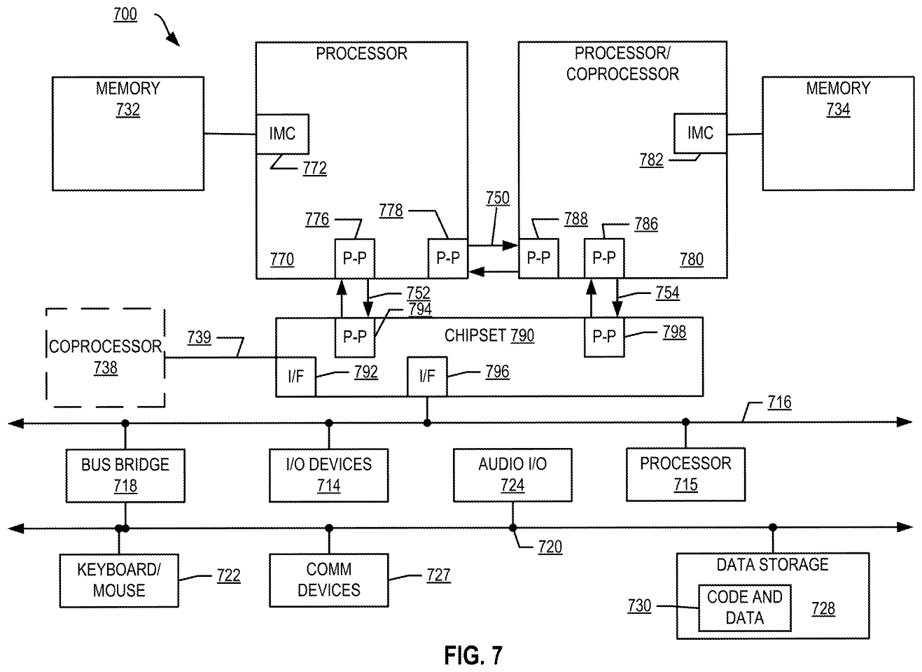

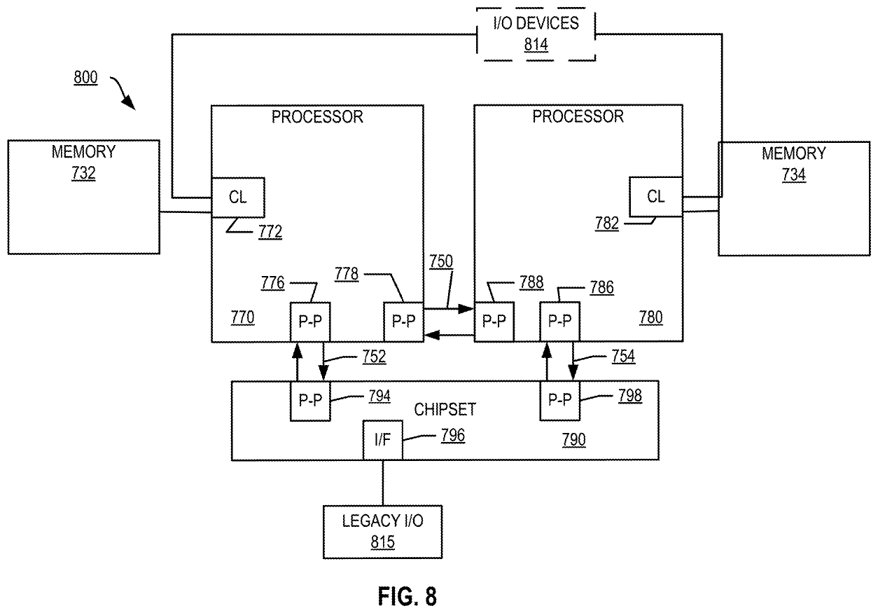

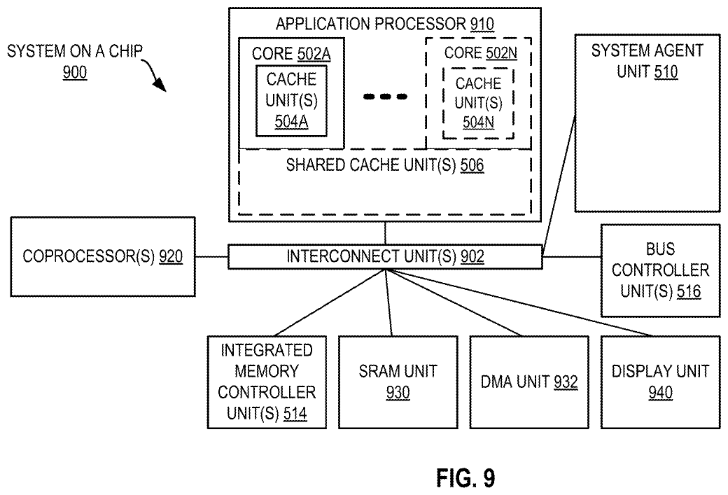

FIG. 1 is a block diagram of a generic linear unit (LU) hardware (HW) accelerator 100 according to an embodiment of the invention. The apparatus shown in FIG. 1 may be implemented in logic gates and/or any other type of circuitry, all or parts of which may be integrated into the circuitry of a processing device or any other apparatus in a computer or other information processing system. For example, the apparatus may be implemented in any of core 490 in FIG. 4B, cores 502A to 502N in FIG. 5, processors 610/615 in FIG. 6, processors 770/780 in FIGS. 7 and 8, and cores 902A to 902N in FIG. 9, each as described below.

As shown in the embodiment of FIG. 1, LU HW accelerator 100 has five inputs and one output. Input 110 is to receive an input tensor ‘x’ to be transformed by any of a variety of functions performed LU HW accelerator 100. Input 112 is to receive a threshold ‘t’ below which the function is applied to the input tensor. Input 114 is to receive an exponential enable ‘e’ that may enable the optional application of an exponential function on the input tensor. Input 116 is to receive scaling factor ‘s’ that may be used in an optional multiply function. Input 118 is to receive a bias factor ‘b’ that may be used in an optional add function. Output 160 is to provide the output tensor ‘y’ that results from the transformation.

As shown in the embodiment of FIG. 1, LU HW accelerator 100 includes comparator 120, exponential subunit 130, multiplier subunit 140, and adder subunit 150. Comparator 120 is to receive the input tensor and the threshold and to check whether the input tensor is greater than the threshold. If it is, then comparator 120 asserts a logical ‘0’ value that goes into each of the enable inputs of exponential subunit 130, multiplier subunit 140, and adder subunit 150. Therefore, if the input tensor is greater than the threshold, then no transformation is performed.

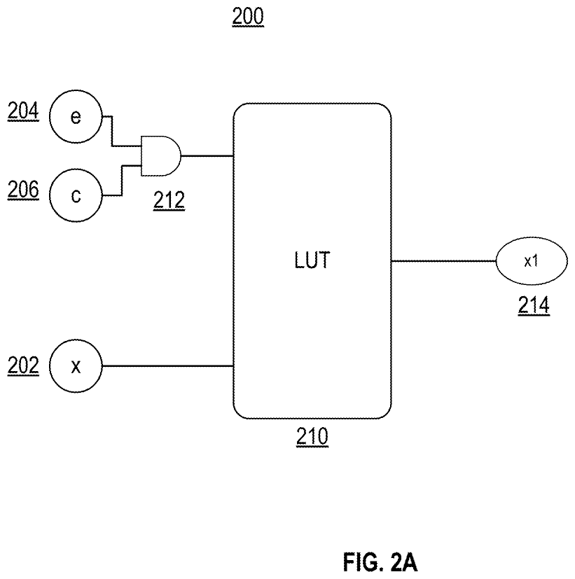

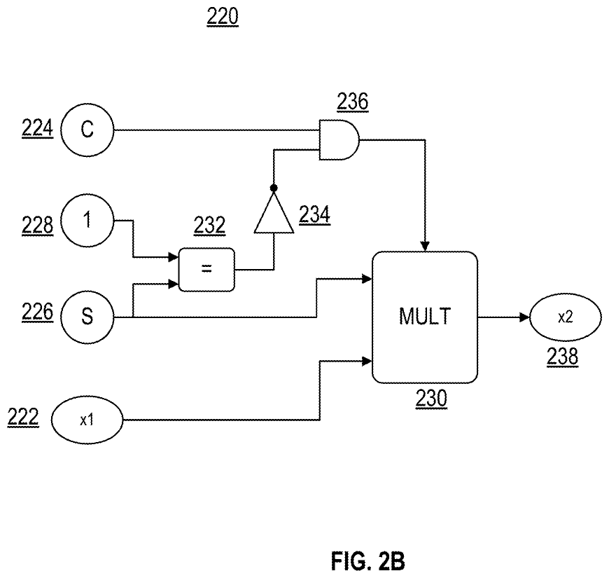

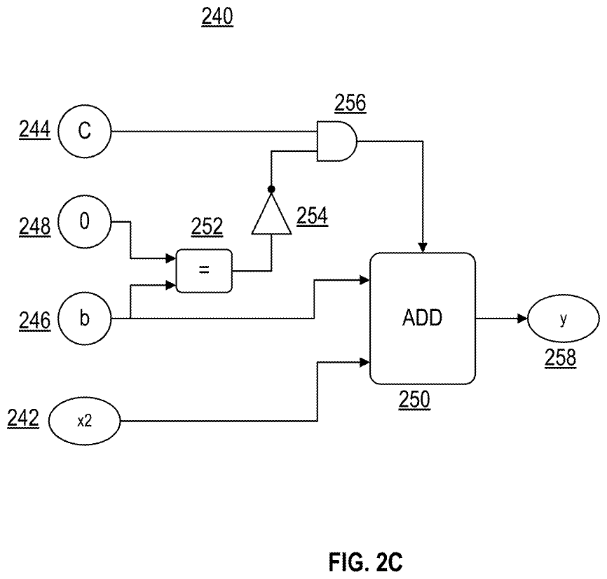

Examples of an exponential subunit, a multiplier subunit, and an adder subunit, corresponding to exponential subunit 130, multiplier subunit 140, and adder subunit 150, respectively, are described below by reference to FIGS. 2B, 2B, and 2C respectively.

FIG. 2A is a block diagram of an exponential subunit 200 of a generic linear unit hardware accelerator (e.g., LU HW accelerator 100) according to an embodiment of the invention. As shown in the embodiment of FIG. 2A, exponential subunit 200 has three inputs and one output. Input 202 is to receive input tensor ‘x’ (e.g., from input 110 in FIG. 1). Input 204 is to receive exponential enable ‘e’ (e.g., from input 114 in FIG. 1). Input 206 is to receive threshold compare assertion ‘c’ from the comparator (e.g., the output of comparator 120 in FIG. 1). Output 214 is to provide an intermediate output tensor ‘x1’ to the multiplier subunit.

As shown in the embodiment of FIG. 2A, exponential subunit 200 includes AND gate 212 and lookup table 210. Exponential subunit 200 may be disabled (pass-through mode) by default such that input tensor ‘x’ is propagated directly to intermediate output tensor ‘x1’ by default. Exponential subunit 200 may be enabled (e.g., by AND gate 212) if both of two conditions are true: exponential enable ‘e’ is asserted, and the input tensor is below the threshold (e.g., the value of ‘c’ is a logical ‘1’). When enabled, exponential subunit 200 approximates the exponential using a linear piecewise approximation algorithm using values looked up from lookup table 210. The values in lookup table 210 may be loaded at reset.

FIG. 2B is a block diagram of a multiplier subunit 220 of a generic linear unit hardware accelerator (e.g., LU HW accelerator 100) according to an embodiment of the invention. As shown in the embodiment of FIG. 2B, multiplier subunit 220 has four inputs and one output. Input 222 is to receive an intermediate input tensor ‘x1’ (e.g., the output of exponential subunit 200 in FIG. 2A). Input 224 is to receive threshold compare assertion ‘c’ from the comparator (e.g., the output of comparator 120 in FIG. 1). Input 226 is to receive scaling factor ‘s’ (e.g., from input 116 in FIG. 1). Input 228 is hardwired to receive a logical ‘1’ value. Output 238 is to provide an intermediate output tensor ‘x2’ to the adder subunit.

As shown in the embodiment of FIG. 2B, multiplier subunit 220 includes comparator 232, inverter 234, AND gate 236, and multiplier 230. Multiplier 230 may be disabled (pass-through mode) by default such that input tensor ‘x1’ is propagated directly to intermediate output tensor ‘x2’ by default. Multiplier 230 may be enabled (e.g., by AND gate 236) if both of two conditions are true: the input tensor is below the threshold (e.g., the value of ‘c’ is a logical ‘1’), and scaling factor ‘s’ is not equal to ‘1’ (e.g., as determined by comparator 232 and inverter 234). When enabled, multiplier 230 performs an elementwise implementation of the multiplication function ‘x2=s*x1’ unless s=0, in which case multiplier 230 is bypassed an x2 is set directly to ‘0’.

FIG. 2C is a block diagram of an adder subunit 240 of a generic linear unit hardware accelerator (e.g., LU HW accelerator 100) according to an embodiment of the invention. As shown in the embodiment of FIG. 2C, adder subunit 240 has four inputs and one output. Input 242 is to receive an intermediate input tensor ‘x2’ (e.g., the output of multiplier subunit 220 in FIG. 2B). Input 244 is to receive threshold compare assertion ‘c’ from the comparator (e.g., the output of comparator 120 in FIG. 1). Input 246 is to receive bias factor ‘b’ (e.g., from input 118 in FIG. 1). Input 248 is hardwired to receive a logical ‘0’ value. Output 258 is to provide an output tensor ‘y’ (e.g., the output of LU HW accelerator 100 in FIG. 1).

As shown in the embodiment of FIG. 2C, adder subunit 240 includes comparator 252, inverter 254, AND gate 256, and adder 250. Adder 250 may be disabled (pass-through mode) by default such that input tensor ‘x2’ is propagated directly to output tensor ‘y’ by default. Adder 250 may be enabled (e.g., by AND gate 256) if both of two conditions are true: the input tensor is below the threshold (e.g., the value of ‘c’ is a logical ‘1’), and bias factor ‘b’ is not equal to ‘0’ (e.g., as determined by comparator 252 and inverter 254). When enabled, adder 250 performs an elementwise implementation of the multiplication function ‘y=b+x2’.

Thus, embodiments provide for a generic LU HW accelerator with a simple, single interface. In an embodiment, an application programmer interface (API) may be provided with a single instruction that resembles the following API call:
generic_linear_unit (x, threshold, bias, scale, exp)

Therefore, common linear unit functions may be mapped to the generic linear unit. Examples are shown in Table 1.

TABLE 1

| | input | | | | |
|---|---|---|---|---|---|
| | tensor | threshold | bias | scale | exp |
| Function | ‘x’ | ‘t’ | ‘b’ | ‘s’ | ‘e’ |
| exponential | x | 0 | −alpha | alpha | 1 |
| elu (x, alpha) | | | | | |
| Rectified | x | 0 | 0 | 1 | 0 |
| relu (x) | | | | | |
| leaky rectified | x | 0 | 0 | alpha | 0 |
| leaky_relu (x, alpha) | | | | | |
| parametric rectified | x | 0 | 0 | slope | 0 |
| prelu (x, slope) | | | | | |
| scaled exponential | x | 0 | −gamma | gamma | 1 |
| selu (x, alpha, | | | * alpha | * alpha | |
| gamma) − positive | | | | | |
| branch | | | | | |
| thresholded rectified | x | alpha | 0 | 1 | 0 |
| thresholded_relu (x, | | | | | |
| alpha) | | | | | |

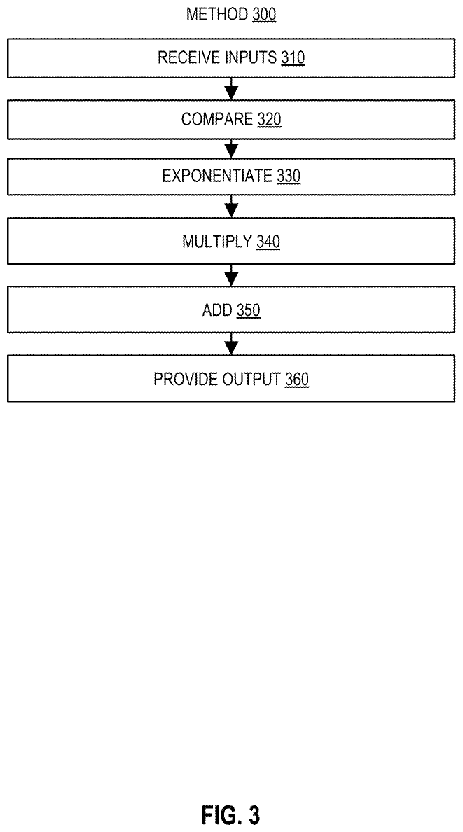

FIG. 3 is a diagram illustrating a method of operation of a generic linear unit hardware accelerator according to an embodiment of the invention.

In 310 of method 300, a generic LU HW accelerator may receive inputs ‘x’, ‘b’, ‘s,’ and ‘e’ as described above. In 320, a compare stage may be performed, in which ‘x’ is compared to T as described above. In 330, an exponential stage may be performed as described above. In 340, a multiplier stage may be performed, as described above. In 350 an adder stage may be performed, as described above. In 360, an output tensor may be provided as described above.

### Exemplary Core Architectures, Processors, and Computer Architectures

The figures below detail exemplary architectures and systems to implement embodiments of the above.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput). Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip that may include on the same die the described CPU (sometimes referred to as the application core(s) or application processor(s)), the above described coprocessor, and additional functionality. Exemplary core architectures are described next, followed by descriptions of exemplary processors and computer architectures.

### Exemplary Core Architectures

### In-Order and Out-of-Order Core Block Diagram

FIG. 4A is a block diagram illustrating both an exemplary in-order pipeline and an exemplary register renaming, out-of-order issue/execution pipeline according to embodiments of the invention. FIG. 4B is a block diagram illustrating both an exemplary embodiment of an in-order architecture core and an exemplary register renaming, out-of-order issue/execution architecture core to be included in a processor according to embodiments of the invention. The solid lined boxes in FIGS. 4A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 4A, a processor pipeline 400 includes a fetch stage 402, a length decode stage 404, a decode stage 406, an allocation stage 408, a renaming stage 410, a scheduling (also known as a dispatch or issue) stage 412, a register read/memory read stage 414, an execute stage 416, a write back/memory write stage 418, an exception handling stage 422, and a commit stage 424.

FIG. 4B shows processor core 490 including a front-end unit 430 coupled to an execution engine unit 450, and both are coupled to a memory unit 470. The core 490 may be a reduced instruction set computing (RISC) core, a complex instruction set computing (CISC) core, a very long instruction word (VLIW) core, or a hybrid or alternative core type. As yet another option, the core 490 may be a special-purpose core, such as, for example, a network or communication core, compression engine, coprocessor core, general purpose computing graphics processing unit (GPGPU) core, graphics core, or the like.

The front-end unit 430 includes a branch prediction unit 432, which is coupled to an instruction cache unit 434, which is coupled to an instruction translation lookaside buffer (TLB) 436, which is coupled to an instruction fetch unit 438, which is coupled to a decode unit 440. The decode unit 440 (or decoder) may decode instructions, and generate as an output one or more micro-operations, micro-code entry points, microinstructions, other instructions, or other control signals, which are decoded from, or which otherwise reflect, or are derived from, the original instructions. The decode unit 440 may be implemented using various different mechanisms. Examples of suitable mechanisms include, but are not limited to, look-up tables, hardware implementations, programmable logic arrays (PLAs), microcode read only memories (ROMs), etc. In one embodiment, the core 490 includes a microcode ROM or other medium that stores microcode for certain macroinstructions (e.g., in decode unit 440 or otherwise within the front-end unit 430). The decode unit 440 is coupled to a rename/allocator unit 452 in the execution engine unit 450.

The execution engine unit 450 includes the rename/allocator unit 452 coupled to a retirement unit 454 and a set of one or more scheduler unit(s) 456. The scheduler unit(s) 456 represents any number of different schedulers, including reservations stations, central instruction window, etc. The scheduler unit(s) 456 is coupled to the physical register file(s) unit(s) 458. Each of the physical register file(s) units 458 represents one or more physical register files, different ones of which store one or more different data types, such as scalar integer, scalar floating point, packed integer, packed floating point, vector integer, vector floating point, status (e.g., an instruction pointer that is the address of the next instruction to be executed), etc. In one embodiment, the physical register file(s) unit 458 comprises a vector registers unit, a write mask registers unit, and a scalar registers unit. These register units may provide architectural vector registers, vector mask registers, and general-purpose registers. The physical register file(s) unit(s) 458 is overlapped by the retirement unit 454 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement unit 454 and the physical register file(s) unit(s) 458 are coupled to the execution cluster(s) 460. The execution cluster(s) 460 includes a set of one or more execution units 462 and a set of one or more memory access units 464. The execution units 462 may perform various operations (e.g., shifts, addition, subtraction, multiplication) and on various types of data (e.g., scalar floating point, packed integer, packed floating point, vector integer, vector floating point). While some embodiments may include a number of execution units dedicated to specific functions or sets of functions, other embodiments may include only one execution unit or multiple execution units that all perform all functions. The scheduler unit(s) 456, physical register file(s) unit(s) 458, and execution cluster(s) 460 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which only the execution cluster of this pipeline has the memory access unit(s) 464). It should also be understood that where separate pipelines are used, one or more of these pipelines may be out-of-order issue/execution and the rest in-order.

The set of memory access units 464 is coupled to the memory unit 470, which includes a data TLB unit 472 coupled to a data cache unit 474 coupled to a level 2 (L2) cache unit 476. In one exemplary embodiment, the memory access units 464 may include a load unit, a store address unit, and a store data unit, each of which is coupled to the data TLB unit 472 in the memory unit 470. The instruction cache unit 434 is further coupled to a level 2 (L2) cache unit 476 in the memory unit 470. The L2 cache unit 476 is coupled to one or more other levels of cache and eventually to a main memory.

By way of example, the exemplary register renaming, out-of-order issue/execution core architecture may implement the pipeline 400 as follows: 1) the instruction fetch 438 performs the fetch and length decoding stages 402 and 404; 2) the decode unit 440 performs the decode stage 406; 3) the rename/allocator unit 452 performs the allocation stage 408 and renaming stage 410; 4) the scheduler unit(s) 456 performs the schedule stage 412; 5) the physical register file(s) unit(s) 458 and the memory unit 470 perform the register read/memory read stage 414; the execution cluster 460 perform the execute stage 416; 6) the memory unit 470 and the physical register file(s) unit(s) 458 perform the write back/memory write stage 418; 7) various units may be involved in the exception handling stage 422; and 8) the retirement unit 454 and the physical register file(s) unit(s) 458 perform the commit stage 424.

The core 490 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.), including the instruction(s) described herein. In one embodiment, the core 490 includes logic to support a packed data instruction set extension (e.g., AVX1, AVX2), thereby allowing the operations used by many multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in an in-order architecture. While the illustrated embodiment of the processor also includes separate instruction and data cache units 434/474 and a shared L2 cache unit 476, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor.

FIG. 5 is a block diagram of a processor 500 that may have more than one core, may have an integrated memory controller, and may have integrated graphics according to embodiments of the invention. The solid lined boxes in FIG. 5 illustrate a processor 500 with a single core 502A, a system agent 510, a set of one or more bus controller units 516, while the optional addition of the dashed lined boxes illustrates an alternative processor 500 with multiple cores 502A-N, a set of one or more integrated memory controller unit(s) 514 in the system agent unit 510, and special purpose logic 508.

Thus, different implementations of the processor 500 may include: 1) a CPU with the special purpose logic 508 being integrated graphics and/or scientific (throughput) logic (which may include one or more cores), and the cores 502A-N being one or more general purpose cores (e.g., general purpose in-order cores, general purpose out-of-order cores, a combination of the two); 2) a coprocessor with the cores 502A-N being a large number of special purpose cores intended primarily for graphics and/or scientific (throughput); and 3) a coprocessor with the cores 502A-N being a large number of general purpose in-order cores. Thus, the processor 500 may be a general-purpose processor, coprocessor or special-purpose processor, such as, for example, a network or communication processor, compression engine, graphics processor, GPGPU (general purpose graphics processing unit), a high-throughput many integrated core (MIC) coprocessor (including 30 or more cores), embedded processor, or the like. The processor may be implemented on one or more chips. The processor 500 may be a part of and/or may be implemented on one or more substrates using any of a number of process technologies, such as, for example, BiCMOS, CMOS, or NMOS.

The memory hierarchy includes one or more levels of cache within the cores, a set or one or more shared cache units 506, and external memory (not shown) coupled to the set of integrated memory controller units 514. The set of shared cache units 506 may include one or more mid-level caches, such as level 2 (L2), level 3 (L3), level 4 (L4), or other levels of cache, a last level cache (LLC), and/or combinations thereof. While in one embodiment a ring-based interconnect unit 512 interconnects the integrated graphics logic 508 (integrated graphics logic 508 is an example of and is also referred to herein as special purpose logic), the set of shared cache units 506, and the system agent unit 510/integrated memory controller unit(s) 514, alternative embodiments may use any number of well-known techniques for interconnecting such units. In one embodiment, coherency is maintained between one or more cache units 506 and cores 502A-N.

In some embodiments, one or more of the cores 502A-N are capable of multi-threading. The system agent 510 includes those components coordinating and operating cores 502A-N. The system agent unit 510 may include for example a power control unit (PCU) and a display unit. The PCU may be or include logic and components needed for regulating the power state of the cores 502A-N and the integrated graphics logic 508. The display unit is for driving one or more externally connected displays.

The cores 502A-N may be homogenous or heterogeneous in terms of architecture instruction set; that is, two or more of the cores 502A-N may be capable of execution the same instruction set, while others may be capable of executing only a subset of that instruction set or a different instruction set.

### Exemplary Computer Architectures

FIGS. 6-9 are block diagrams of exemplary computer architectures. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

Referring now to FIG. 6, shown is a block diagram of a system 600 in accordance with one embodiment of the present invention. The system 600 may include one or more processors 610, 615, which are coupled to a controller hub 620. In one embodiment, the controller hub 620 includes a graphics memory controller hub (GMCH) 690 and an Input/Output Hub (IOH) 650 (which may be on separate chips); the GMCH 690 includes memory and graphics controllers to which are coupled memory 640 and a coprocessor 645; the IOH 650 couples input/output (I/O) devices 660 to the GMCH 690. Alternatively, one or both of the memory and graphics controllers are integrated within the processor (as described herein), the memory 640 and the coprocessor 645 are coupled directly to the processor 610, and the controller hub 620 in a single chip with the IOH 650.

The optional nature of additional processors 615 is denoted in FIG. 6 with broken lines. Each processor 610, 615 may include one or more of the processing cores described herein and may be some version of the processor 500.

The memory 640 may be, for example, dynamic random-access memory (DRAM), phase change memory (PCM), or a combination of the two. For at least one embodiment, the controller hub 620 communicates with the processor(s) 610, 615 via a multi-drop bus, such as a frontside bus (FSB), point-to-point interface such as QuickPath Interconnect (QPI), or similar connection 695.

In one embodiment, the coprocessor 645 is a special-purpose processor, such as, for example, a high-throughput MIC processor, a network or communication processor, compression engine, graphics processor, GPGPU, embedded processor, or the like. In one embodiment, controller hub 620 may include an integrated graphics accelerator.

There can be a variety of differences between the physical resources 610, 615 in terms of a spectrum of metrics of merit including architectural, microarchitectural, thermal, power consumption characteristics, and the like.

In one embodiment, the processor 610 executes instructions that control data processing operations of a general type. Embedded within the instructions may be coprocessor instructions. The processor 610 recognizes these coprocessor instructions as being of a type that should be executed by the attached coprocessor 645. Accordingly, the processor 610 issues these coprocessor instructions (or control signals representing coprocessor instructions) on a coprocessor bus or other interconnect, to coprocessor 645. Coprocessor(s) 645 accept and execute the received coprocessor instructions.

Referring now to FIG. 7, shown is a block diagram of a first more specific exemplary system 700 in accordance with an embodiment of the present invention. As shown in FIG. 7, multiprocessor system 700 is a point-to-point interconnect system, and includes a first processor 770 and a second processor 780 coupled via a point-to-point interconnect 750. Each of processors 770 and 780 may be some version of the processor 500. In one embodiment of the invention, processors 770 and 780 are respectively processors 610 and 615, while coprocessor 738 is coprocessor 645. In another embodiment, processors 770 and 780 are respectively processor 610 and coprocessor 645.

Processors 770 and 780 are shown including integrated memory controller (IMC) units 772 and 782, respectively. Processor 770 also includes as part of its bus controller unit's point-to-point (P-P) interfaces 776 and 778; similarly, second processor 780 includes P-P interfaces 786 and 788. Processors 770, 780 may exchange information via a point-to-point (P-P) interface 750 using P-P interface circuits 778, 788. As shown in FIG. 7, IMCs 772 and 782 couple the processors to respective memories, namely a memory 732 and a memory 734, which may be portions of main memory locally attached to the respective processors.

Processors 770, 780 may each exchange information with a chipset 790 via individual P-P interfaces 752, 754 using point to point interface circuits 776, 794, 786, 798. Chipset 790 may optionally exchange information with the coprocessor 738 via a high-performance interface 792. In one embodiment, the coprocessor 738 is a special-purpose processor, such as, for example, a high-throughput MIC processor, a network or communication processor, compression engine, graphics processor, GPGPU, embedded processor, or the like.

A shared cache (not shown) may be included in either processor or outside of both processors, yet connected with the processors via P-P interconnect, such that either or both processors' local cache information may be stored in the shared cache if a processor is placed into a low power mode.

Chipset 790 may be coupled to a first bus 716 via an interface 796. In one embodiment, first bus 716 may be a Peripheral Component Interconnect (PCI) bus, or a bus such as a PCI Express bus or another third generation I/O interconnect bus, although the scope of the present invention is not so limited.

As shown in FIG. 7, various I/O devices 714 may be coupled to first bus 716, along with a bus bridge 718 which couples first bus 716 to a second bus 720. In one embodiment, one or more additional processor(s) 715, such as coprocessors, high-throughput MIC processors, GPGPU's, accelerators (such as, e.g., graphics accelerators or digital signal processing (DSP) units), field programmable gate arrays, or any other processor, are coupled to first bus 716. In one embodiment, second bus 720 may be a low pin count (LPC) bus. Various devices may be coupled to a second bus 720 including, for example, a keyboard and/or mouse 722, communication devices 727 and a storage unit 728 such as a disk drive or other mass storage device which may include instructions/code and data 730, in one embodiment. Further, an audio I/O 724 may be coupled to the second bus 720. Note that other architectures are possible. For example, instead of the point-to-point architecture of FIG. 7, a system may implement a multi-drop bus or other such architecture.

Referring now to FIG. 8, shown is a block diagram of a second more specific exemplary system 800 in accordance with an embodiment of the present invention. Like elements in FIGS. 7 and 8 bear like reference numerals, and certain aspects of FIG. 7 have been omitted from FIG. 8 in order to avoid obscuring other aspects of FIG. 8.

FIG. 8 illustrates that the processors 770, 780 may include integrated memory and I/O control logic (“CL”) 772 and 782, respectively. Thus, the CL 772, 782 include integrated memory controller units and include I/O control logic. FIG. 8 illustrates that not only are the memories 732, 734 coupled to the CL 772, 782, but also that I/O devices 814 are also coupled to the control logic 772, 782. Legacy I/O devices 815 are coupled to the chipset 790.

Referring now to FIG. 9, shown is a block diagram of a SoC 900 in accordance with an embodiment of the present invention. Similar elements in FIG. 5 bear like reference numerals. Also, dashed lined boxes are optional features on more advanced SoCs. In FIG. 9, an interconnect unit(s) 902 is coupled to: an application processor 910 which includes a set of one or more cores 502A-N, which include cache units 504A-N, and shared cache unit(s) 506; a system agent unit 510; a bus controller unit(s) 516; an integrated memory controller unit(s) 514; a set or one or more coprocessors 920 which may include integrated graphics logic, an image processor, an audio processor, and a video processor; an static random access memory (SRAM) unit 930; a direct memory access (DMA) unit 932; and a display unit 940 for coupling to one or more external displays. In one embodiment, the coprocessor(s) 920 include a special-purpose processor, such as, for example, a network or communication processor, compression engine, GPGPU, a high-throughput MIC processor, embedded processor, or the like.

Embodiments of the mechanisms disclosed herein may be implemented in hardware, software, firmware, or a combination of such implementation approaches. Embodiments of the invention may be implemented as computer programs or program code executing on programmable systems comprising at least one processor, a storage system (including volatile and non-volatile memory and/or storage elements), at least one input device, and at least one output device.

Program code, such as code 730 illustrated in FIG. 7, may be applied to input instructions to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high level procedural or object-oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments of the invention also include non-transitory, tangible machine-readable media containing instructions or containing design data, such as Hardware Description Language (HDL), which defines structures, circuits, apparatuses, processors and/or system features described herein. Such embodiments may also be referred to as program products.

In this specification, operations in flow diagrams may have been described with reference to exemplary embodiments of other figures. However, it should be understood that the operations of the flow diagrams may be performed by embodiments of the invention other than those discussed with reference to other figures, and the embodiments of the invention discussed with reference to other figures may perform operations different than those discussed with reference to flow diagrams. Furthermore, while the flow diagrams in the figures show a particular order of operations performed by certain embodiments of the invention, it should be understood that such order is exemplary (e.g., alternative embodiments may perform the operations in a different order, combine certain operations, overlap certain operations, etc.).

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

What is claimed is:

1. An apparatus comprising:
a comparator;
an exponential subunit;
a multiplier subunit; and
an adder subunit;
wherein the apparatus is to receive an input tensor, a threshold, an exponential enable, a scaling factor, and a bias factor and is to perform a transformation function on the input tensor to generate an output tensor.

2. The apparatus of claim 1, wherein the comparator is to compare the input tensor to the threshold and to disable the exponential subunit, the multiplier subunit, and the adder subunit when the input tensor is greater than the threshold.

3. The apparatus of claim 1, wherein the exponential subunit includes circuitry to enable an exponential operation only when the exponential enable is asserted.

4. The apparatus of claim 3, wherein when the exponential operation is enabled, the exponential subunit is to approximate an exponential for the transformation function.

5. The apparatus of claim 4, wherein the exponential subunit is to use a linear piecewise approximation algorithm to approximate the exponential.

6. The apparatus of claim 5, wherein the exponential subunit includes a lookup table to provide values for the linear piecewise approximation function.

7. The apparatus of claim 1, wherein the multiplier subunit is to use the scaling factor to perform an elementwise multiplication operation for the transformation function.

8. The apparatus of claim 7, wherein the multiplier subunit includes circuitry to disable the elementwise multiplication operation when the scaling factor is equal to one.

9. The apparatus of claim 1, wherein the adder subunit is to use the bias factor to perform an elementwise addition operation for the transformation function.

10. The apparatus of claim 9, wherein the adder subunit includes circuitry to disable the elementwise addition operation when the bias factor is equal to zero.

11. A method comprising:
receiving, by a linear unit hardware accelerator, an input tensor, a threshold, an exponential enable, a scaling factor, and a bias factor;
performing, by the linear unit hardware accelerator, a transformation function on the input tensor to generate an output tensor, wherein the transformation function is determined from a plurality of transformation functions based on the threshold, the exponential enable, the scaling factor, and the bias factor.

12. The method of claim 11, further comprising:
comparing the input tensor to the threshold; and
disabling an exponential subunit, a multiplier subunit, and an adder subunit of the linear unit hardware accelerator when the input tensor is greater than the threshold.

13. The method of claim 11, further comprising enabling an exponential operation only when the exponential enable is asserted.

14. The method of claim 13, further comprising, when the exponential operation is enabled, looking up values in a lookup table for a linear piecewise approximation function to approximate an exponential for the transformation function.

15. The method of claim 11, further comprising using the scaling factor to perform an elementwise multiplication operation for the transformation function.

16. The method of claim 15, further comprising disabling the piecewise multiplication operation when the scaling factor is equal to one.

17. The method of claim 11, further comprising using the bias factor to perform an elementwise addition operation for the transformation function.

18. The method of claim 17, further comprising disabling the elementwise addition operation when the bias factor is equal to zero.

19. An apparatus comprising:
a memory to store an instruction to specify an input tensor, a threshold, an exponential enable, a scaling factor, and a bias factor; and
a linear unit hardware accelerator comprising
a comparator;
an exponential subunit;
a multiplier subunit; and
an adder subunit;
wherein in response to the instruction, the linear unit hardware accelerator is to perform a transformation function on the input tensor to generate an output tensor.

20. The system of claim 19, wherein the transformation function determined from a plurality of transformation functions based on the threshold, the exponential enable, the scaling factor, and the bias factor.
